(19) United States
(12) Patent Application Publication
(10) Pub. No.: US 2008/0314058 A1
(43) Pub. Date: Dec. 25, 2008

(54) Solar Atmospheric Water Harvester

(75) Inventors: Darryl Jones, Salt Ash (AU); Graeme Collins, Medowie (AU)

Correspondence Address: GEORGE A LEONE, SR;CITADEL PATENT LAW, 1117 BROADWAY, SUITE 401, TACOMA, WA, 98402, US

(73) Assignee: HYDROTOWER PTY LIMITED, MEDOWIE (AU)

(21) Appl. No.: 12/065,058

(22) PCT Filed: Sep. 1, 2006
(86) PCT No.: PCT/AU2006/001279

§ 371 Date: Jul. 29, 2008

(30) Foreign Application Priority Data
Sep. 1, 2005 (AU) 2005904795

(51) Int. Cl. C02F 1/14; F25B 27/00

(52) U.S. Cl. 62/235.1

(57) ABSTRACT

The atmospheric water harvester (2) shown in FIG. (1) comprises a centrally located flue in the form of a tower 4 and a surrounding heating enclosure (6) for collecting incident solar energy to heat air which enters its periphery (8). With heating of the air in the heating enclosure (6), an updraught is created within tower (4) as the air from the heating enclosure (6) returns to the atmosphere from the open end of the tower A base structure (10) housing a plurality of wind turbines is provided around the base of the tower. As the heated air flows from the heating enclosure (6) into the tower it is harnessed to rotate the wind turbines. Each wind turbine (20) is provided with associated water collection apparatus (94) comprising a refrigeration system for cooling condensation surfaces to, or below, the dew point of the air to effect the condensation of water from the air onto condensation surfaces of the water collection apparatus for collection. The refrigeration system comprises a compressor (46) for compressing a refrigerant vapour for the cooling of the condensation surfaces and which is driven by the wind turbine (20).

### FIELD OF THE INVENTION

The present invention relates broadly to condensing moisture from the atmosphere to provide a source of water and more particularly, to an atmospheric water harvester that utilises solar energy to drive production of the water.

### BACKGROUND OF THE INVENTION

Changing climate patterns and global population increases means that water shortage is a significant issue. Methods and equipment to reduce water usage and produce drinking water are therefore being considered by organisations and governments throughout the world.

One of the problems with many of the currently available water production alternatives is that they require electrical energy to power drinking water generating equipment. This is particularly true with conventional water desalination plants employing reverse-osmosis technology. These alternatives have two main drawbacks, namely they generate pollution including greenhouse gases and are expensive to operate.

Over the last 15 to 20 years environmentally friendly solar tower power stations have been proposed for generating electricity from solar energy as an alternative to fossil fuel and nuclear power stations. These typically comprise a central tower structure surrounded by a heating enclosure for heating atmospheric air employing radiant solar energy. The heating enclosure opens into the lower region of the tower. Air that enters the heating enclosure is heated by the solar energy and the tower is of a height such that the temperature differential created between the heated air in the heating enclosure and the atmosphere at the top of the tower is sufficient to create an updraft within the tower as the heated air returns to the atmosphere. Electricity is generated by harnessing the updraft to drive one or more wind turbines. Solar tower power stations of this type can potentially be utilised to generate 200 MW of electric power or more depending on the dimensions of the heating enclosure and tower, and the intensity of available solar energy.

### SUMMARY OF THE INVENTION

In a first aspect of the present invention there is provided an atmospheric water harvester, comprising:

a heating enclosure adapted to receive air from the atmosphere and be heated by solar energy to effect heating of the air;

a flue for return of the air from the heating enclosure to the atmosphere, the flue opening to the atmosphere at a sufficient height relative to the heating enclosure to create a draught within the flue;

at least one wind turbine arranged to be driven by the air returning to the atmosphere via the flue from the heating enclosure; and

at least one water collection apparatus comprising at least one condensation surface, and a refrigeration system for cooling the condensation surface to, or below, a dew point of the air to effect the condensation of airborne moisture onto the condensation surface for collection, the refrigeration system including a compressor for compressing refrigerant vapour and a condensor for condensing the compressed refrigerant vapour into liquid refrigerant, and the wind turbine being arranged to drive the compressor.

Typically, the condensation surface is arranged for contact with the air heated in the heating enclosure as the air returns to the atmosphere via the flue, the airborne moisture being condensed from the heated air. Alternatively, the condensation surface may be arranged for contact with further air from the atmosphere other than the air heated within the heating enclosure, the airborne moisture being condensed from the further air.

Typically also, the wind turbine is coupled to the compressor for driving the compressor. Preferably, the wind turbine incorporates a gear box that couples an output shaft of the wind turbine to the compressor. However, any other suitable coupling for mechanically coupling the wind turbine to the compressor for operation thereof may be utilised. In another embodiment, the wind turbine is coupled to an electric generator for generating electricity to power operation of the compressor.

Preferably, the water collection apparatus further comprises water collection means for collecting water condensed onto the condensation surface from the airborne moisture. Typically, the water is collected from the condensation surface by the water collection means by gravity. Preferably, the water collection means comprises a holding reservoir that receives the water from the condensation surface.

Preferably, the refrigeration system further comprises an evaporator for evaporation of the liquid refrigerant into refrigerant vapour to effect the cooling of the condensation surface. Most preferably, the condensation surface is a surface of the evaporator.

In a particularly preferred embodiment, the condensor is arranged for contact with air flowing from the condensation surface for cooling of the condensor to facilitate the condensing of the compressed refrigerant vapour into the liquid refrigerant.

Preferably, the atmospheric water harvester also comprises air flow control means for controlling flow rate of the air flowing into contact with the condensation surface to enhance the efficiency of the condensation of the airborne moisture onto the condensation surface.

Preferably, the air flow control means incorporates at least one adjustable air inlet operable to allow the air to flow to the condensor by-passing contact with the condensation surface such that the flow rate of the air flowing into contact with the condensor is adjusted compared to the flow rate of the air flowing into contact with the condensation surface. This allows increased air flow to the condensor to cool the condensor for condensing of the compressed refrigerant vapour, substantially without increasing the flow rate of the air to the condensation surface and thereby adversely affecting condensation of water from the air onto the condensation surface.

Preferably, the heating enclosure will comprise a plurality of radially directed heating chambers disposed around the tower and which open to a base region of the flue, each heating chamber being respectively provided with one or more air inlets for entry of the air from the atmosphere.

Typically, the, or each, wind turbine is arranged in a central region of the heating enclosure in which the flue is disposed. The wind turbine(s) generally incorporate blades rotatable about a turbine rotation axis. The turbine rotation axis may be vertical, horizontal or inclined at an oblique angle, respectively. In one or more embodiments, a wind turbine may be arranged within a lower region of the flue. Alternatively, the atmospheric water harvester may comprise a plurality of wind turbines, the wind turbines being radially orientated with respect to the central region of the heating enclosure and circumferentially spaced apart from each other. In a particularly preferred embodiment, each wind turbine is arranged to be driven by air flowing from a corresponding one of the heating chambers, respectively.

The flue may comprise a shaft, pipe, chimney, tower or other structure through which the air heated in the heating enclosure returns to the atmosphere. The flue may be substantially vertical or extend upwardly from the heating enclosure at an oblique angle. In a particularly preferred embodiment the flue will comprise a tower.

In a preferred embodiment the at least one water collection apparatus is disclosed at a position within the heating enclosure at which the average velocity the air returning to the atmosphere, whilst in use, is within a range of between 2.0 m/s and 3.5 m/s.

In another preferred embodiment the at least one water collection apparatus is disclosed at a position within the heating enclosure at which the average temperature of the air returning to the atmosphere, whilst in use, is substantially equal to, or no more than 5° C. greater than, an ambient temperature of air at a periphery of the heating enclosure.

The wind turbine may be mechanically coupled to the compressor by means of a rotatably mounted drive shaft extending from the turbine to the compressor. Alternatively, the turbine may be electrically coupled to the compressor by means of an electrical generator driven by the wind turbine so as to generate electricity that is conducted via conductors extending between the turbine to the compressor. In another embodiment the refrigeration system is disposed adjacent the wind turbine such that, in use, the refrigeration system is driven by the turbine to produce chilled gases that are communicated along at least one thermally insulated pipe from the refrigeration system to the condensation surface.

All publications mentioned in this specification are herein incorporated by reference in their entirety. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed anywhere before the priority date of this application.

Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps, unless the context of the invention indicates otherwise.

In order that the nature of the present invention may be more clearly understood, preferred forms thereof will now be described, by way of example only, with reference to a number of preferred embodiments with reference to the accompanying figures.

### BRIEF DESCRIPTION OF THE ACCOMPANYING FIGURES

FIG. 1 is a schematic side view of an atmospheric water harvester embodied by the present invention;

FIG. 2 is a schematic plan view of the atmospheric water harvester of FIG. 1;

FIG. 3 is a schematic partial cross-sectional view of the atmospheric water harvester of FIG. 1;

FIG. 4 is a schematic partial side cross-sectional view of a further atmospheric water harvester embodied by the present invention;

FIG. 5 is a schematic partial cross-sectional view of yet another atmospheric water harvester embodied by the present invention;

FIG. 6 is a schematic diagram of a refrigeration system of water collection apparatus of an embodiment of the present invention;

FIG. 7 is a schematic side view taken through B-B of FIG. 6;

FIG. 8 is a schematic diagram showing further water collection apparatus embodied by the present invention;

FIG. 9 is a schematic side view of another wind turbine of an embodiment of the present invention;

FIG. 10 is a schematic view showing water collection apparatus housed in the wind turbine of FIG. 9;

FIG. 11 is a schematic view showing operation of the refrigeration system of FIG. 6;

FIG. 12 is a schematic diagram of the refrigeration system of the water collection apparatus of FIG. 6;

FIG. 13 is a schematic side view of an alternative embodiment of an atmospheric water harvester;

FIG. 14 is a schematic side plan view of the embodiment shown in FIG. 13 with the omission of the roof of the heating enclosure so as to illustrate the interior of the heating chamber; and

FIG. 15 is a graph of the average air flow velocity versus distance from the outer periphery of the heating enclosure.

### DETAILED DESCRIPTION OF PREFERRED EMBODIMENTS OF THE INVENTION

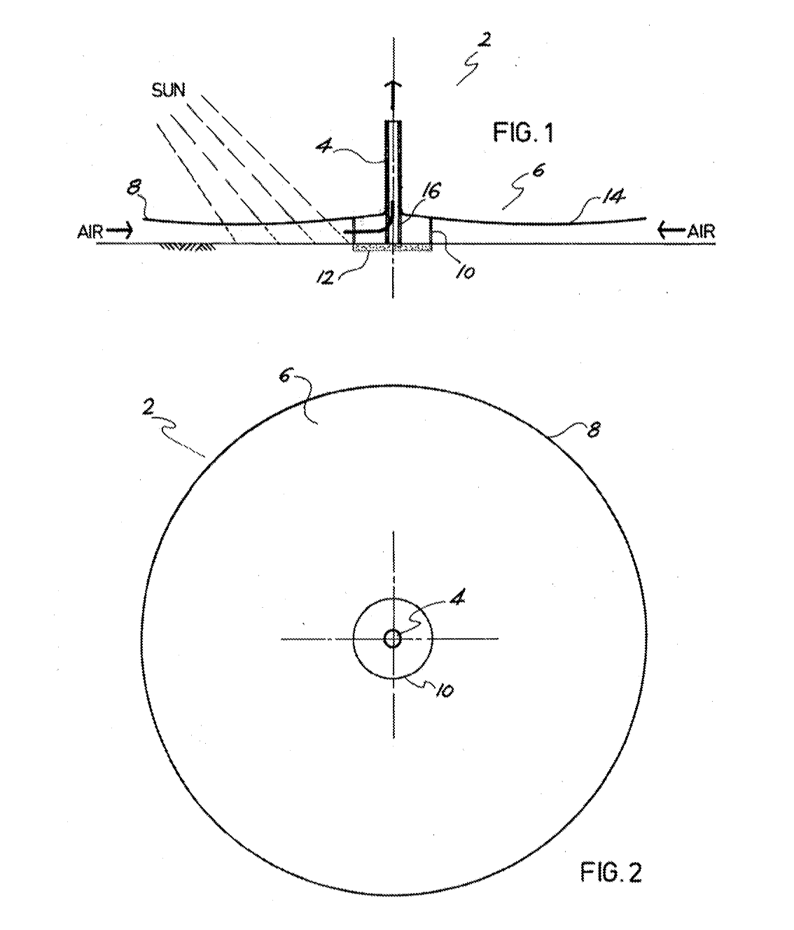

The atmospheric water harvester 2 shown in FIG. 1 comprises a centrally located flue in the form of a tower 4 and a surrounding heating enclosure 6 for collecting incident solar energy to heat air which enters its periphery 8. With heating of the air in the heating enclosure 6, an updraught is created within tower 4 as the air from the heating enclosure 6 returns to the atmosphere from the open end of the tower. A base structure 10 housing a plurality of wind turbines is provided around the base of the tower. As the heated air flows from the heating enclosure 6 into the tower it is harnessed to rotate the wind turbines. As will be described further below, each wind turbine is provided with associated water collection apparatus comprising a refrigeration system for cooling condensation surfaces to, or below, the dew point of the air to effect the condensation of water from the air onto condensation surface(s) of the water collection apparatus for collection. The refrigeration system comprises a compressor for compressing a refrigerant vapour for the cooling of the condensation surfaces and which is driven by the wind turbine. A plan view of atmospheric water harvester 2 is shown in FIG. 2.

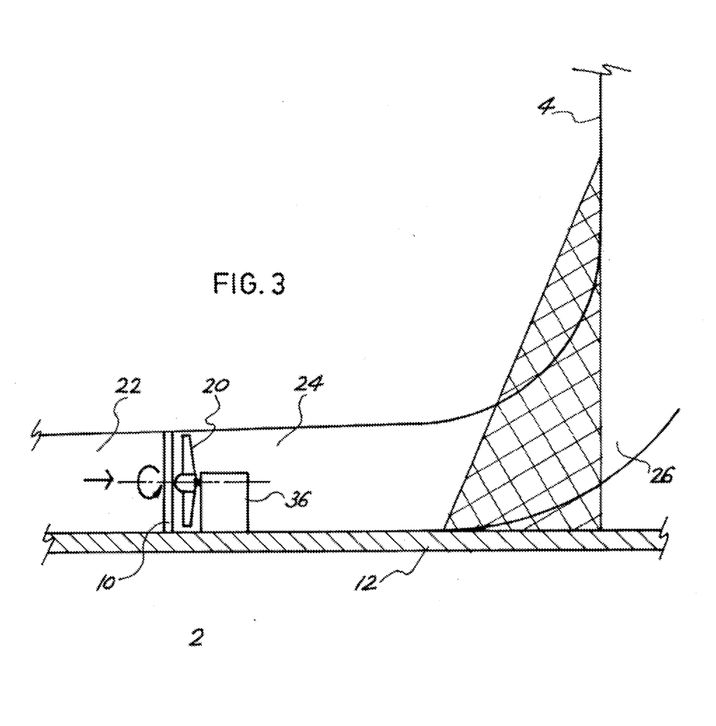

As shown in FIG. 3, the tower 4 is buttressed about its base by reinforced concrete and is supported by reinforced concrete foundations 14. The tower itself is fabricated from steel plate. The heating enclosure 6 has a canopy 16 held aloft by internal supporting walls. The canopy may be formed from any suitable material that permits ingress of solar energy into the interior of the heating enclosure. To enhance retention of heat within the enclosure, the internal walls supporting the canopy may be lined with corrugated zinc coated sheet metal. The heating enclosure thereby acts as a “greenhouse” for heating of the air to generate the updraught through the tower 4 to drive the wind turbines.

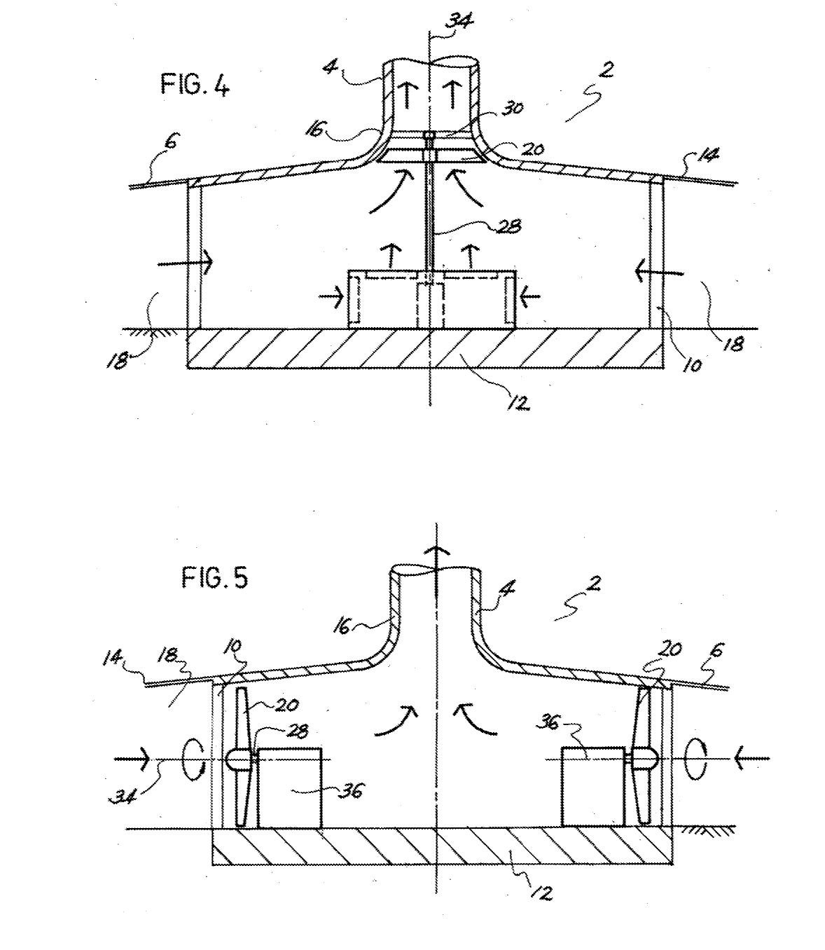

In the embodiment shown in FIG. 3, the heating enclosure 6 is divided into radial heating chambers 18 that fan outwardly from around the base 16 of the tower. Each heating chamber 18 houses a wind turbine 20 and opens into the tower 4 at one end and to the atmosphere via opposite respective openings defined in the periphery 8 of the heating enclosure 6. The heating chambers act to funnel air heated by the incident solar energy through respective confusor 22 regions thereof to each turbine. To minimise turbulent air flow resulting from passage of the air through the blades of the turbines, each heating chamber 18 is further provided with a diffusor region 24, the cross-sectional area of which increases with distance from the corresponding wind turbine 20 into the base of the tower. To minimise drag and turbulence, an arcuate exhaust passageway 26 is provided through the concrete buttress 12 for feeding the heated air from each heating chamber into the tower 4, respectively. The heating chambers 18 may be provided with heater beds to assist heating of the air, that are operable in times of low solar energy input or for night operation when solar energy is not available. The heater beds will typically comprise a plurality of heaters spaced apart along the length of each heating chamber. The heaters may be electric or gas fired and be automatically operated by a central monitoring system in response to decreases in air temperature detected by temperature sensors located within the heating chambers and/or the tower. Remotely controlled shutters can also be provided that are operable to partially or fully close the air inlet opening and corresponding exhaust passageway 26 of each heating chamber to enable the air to be heated to the necessary temperature prior to entering the tower 4. In this way, the flow of air from the heating chambers into the tower can be controlled to maintain the updraught through the tower and maximise efficiency of the atmospheric water harvester 2. That is, in times of lower solar energy availability, different ones of the turbines can be operated by controlling the flow of air through selected one(s) of the heating chambers 18 while others are closed to allow the air to reach a sufficient temperature, to maximise the production of water from the atmosphere for the prevailing atmospheric conditions and available solar energy. Controlling the updraught through the tower is particularly desirable in embodiments where a wind turbine is arranged within the lower throat region of the tower, as exemplified in FIG. 4.

A solar tower power station with a solar heating enclosure of the type described above with discrete heating chambers radiating outwardly from a central tower as outlined above is, for instance, described in U.S. patent application Ser. No. 10/341,559. That disclosure also exemplifies the structural detail of the heating enclosure and its contents are herein incorporated in their entirety. In some embodiments, the tower 4 may comprise a constricted region in which the wind turbine is arranged. The constriction within the tower provides a venturi type effect in which the air flowing up the tower is accelerated through the constriction. An arrangement of this type is for instance described in International Patent Application No. PCT/CA01/00885. As also described in International Patent Application No. PCT/EP2004/010091, the tower may be reinforced by one or more spoked reinforcement structures, each comprising wire cable spokes that are tensed between an outer pressure ring of the tower and an inner anchoring hub disposed in a transverse cross-sectional plane of the tower, respectively. However, it will be understood by persons skilled in the art that any suitable known such solar tower and heating enclosure arrangements may be employed.

Typically, the tower of an atmospheric water harvester 2 embodied by the present invention will be of a height to create an updraught sufficient to drive the wind turbine(s) 20 of the water harvester. Typically, the tower will have a height of at least 200 meters, more preferably a height of 400 meters or 500 meters and most preferably, a height of 800 meters or 1,000 meters or more. The diameter of the tower will normally be at least 50 meters, 75 meters or 100 meters or more. Most preferably, the tower will have a diameter of about 130 meters or more.

The heating enclosure 6 will typically have a canopy area of at least about 1,000 hectares, more preferably at least about 2,000 hectares and most preferably, a canopy area of at least about 4,000 hectares. The canopy 16 of the heating enclosure may, for instance, be provided by glass, polycarbonate sheeting, plastic film or a combination of the foregoing. Generally, the heating enclosure will be circular in form with a diameter of at least about 1,000 meters, more preferably at least about 2,000 meters or 3,000 meters and most preferably, a diameter of about 3,500 meters.

In the embodiment shown in FIG. 4, the output shaft 28 of the wind turbine 20 is rotatably supported within the tower 4 as indicated by the numeral 30 such that the blades 32 of the wind turbine are mounted in the throat of the tower for being rotated about turbine axis 34 with flow of the air from the surrounding heating enclosure 6 into the tower 4, as indicated by the arrows. In some embodiments the wind turbine further comprises a housing 36 in which the refrigeration system of the water collection apparatus is housed for condensing water from the air from the heating enclosure which enters the housing through air inlet 38 from the heating enclosure 6 before exiting the housing through air outlet 40 to the tower.

Rather than a single centrally located wind turbine, the embodiment of the atmospheric water harvester shown in FIG. 5 is provided with a plurality of wind turbines driven by heated air passing from corresponding respective heating chambers 18. While only two wind turbines are shown in FIG. 5, an atmospheric water harvester of this type will normally have a plurality of wind turbines equidistantly spaced circumferentially around the base of the tower for being driven by the passage of the heated air flowing from respective heating chambers into the tower. The housing 36 of each turbine houses a refrigeration system as described above for condensing water from the passing air. In a particularly preferred embodiment, thirty-six wind turbines are arranged around the tower, one wind turbine to each heating chamber, respectively.

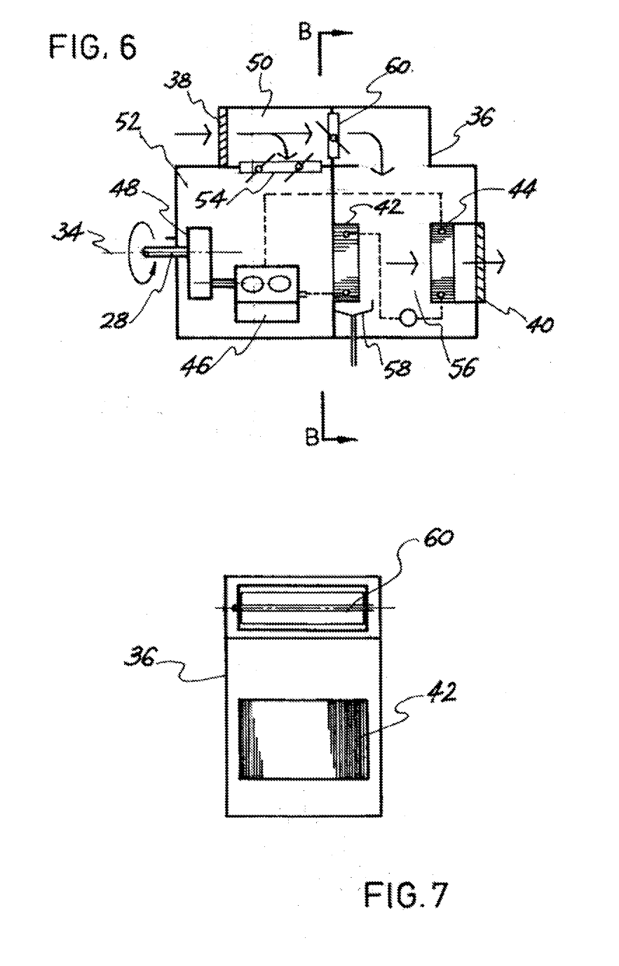

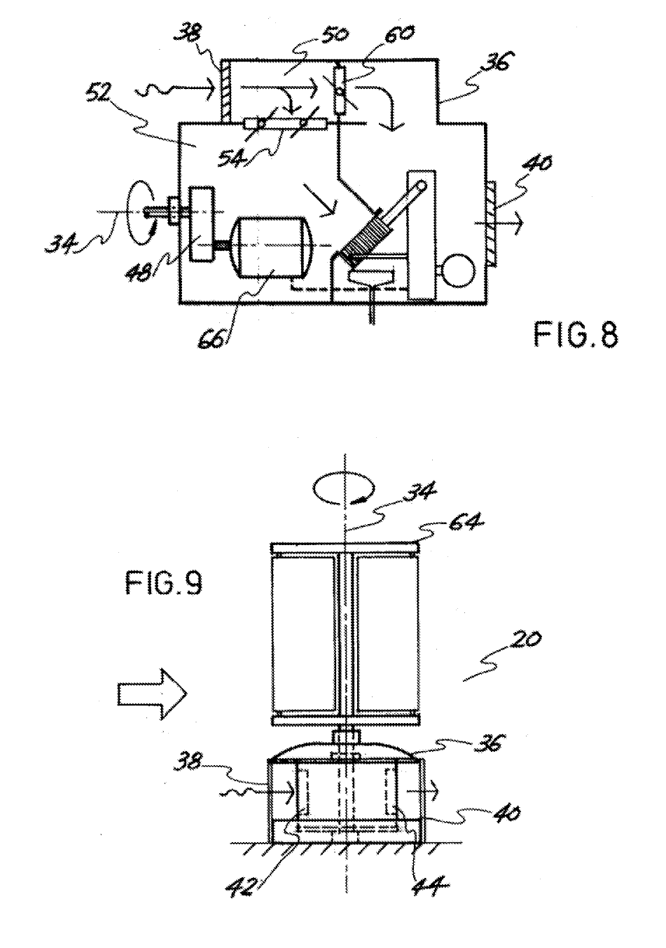

The condensing of the water from the heated air will now be described with reference to FIGS. 6 to 12. Turning firstly to FIG. 6, the refrigeration system of the water collection apparatus disposed within housing 36 of a wind turbine 20 comprises an evaporator 42, a condenser 44 and a compressor 46. As can be seen, the compressor is coupled to the output shaft 28 of the wind turbine by a gear box 48. However, as will be readily apparent to persons skilled in the art, any suitable coupling for transferring rotational kinetic energy of the output shaft 28 to the compressor 46 may be used. For example, rather than a gear box, hydraulic couplings, including hydrostatic couplings, may be used.

The evaporator 42 is provided with a plurality of spaced apart fins through which the air from the heating enclosure flows and which provide condensation surfaces for the condensation of water from the air upon the condensation surfaces being cooled to, or below, the dew point of the air by the refrigeration system.

In order to assist in the optimisation of operational efficiency, the interior of the housing 36 is divided into separate compartments to which the air entering the housing is directed by air flow control means. More particularly, heated air from the heating enclosure 6 flowing into the housing 36 through air inlet 38 initially enters air intake chamber 50 from where it flows to evaporator 42 through compressor chamber 54 housing compressor 46. The flow of air from the air intake chamber 50 to the compressor chamber 54 is regulated by dampers of the air control means in the form of air intake valves 52. From the compressor chamber 54, the air flows into contact with the condensation surfaces of the evaporator 42 prior to entering condensor chamber 56 in which the condensor 44 is located. As the air contacts the condensation surfaces of the evaporator, heat is drawn from the air and water condenses on the condensation surfaces from where it flows under gravity into water collection means in the form of a funnel 58 which directs the water to a holding reservoir comprising a tank. From the tank, the water is pumped to an external storage reservoir.

The cooled air from the evaporator 42 then flows into contact with the condenser 44, drawing off heat from the condensor. This in turn cools refrigerant vapour within the condenser, facilitating the condensing of the refrigerant vapour into liquid refrigerant. The warmed dry air flowing from the condensor then exits the housing 36 of the wind turbine and flows into the tower 4 of the atmospheric water harvester. A hinged by-pass damper 60 of the air control means regulates the flow of air from the air intake chamber 50 into the condensor chamber 56 as will be further described below.

The air flowing through the housing 36 therefore serves two primary functions, namely providing a source of moisture which condenses onto the condensation surfaces of the evaporator for collection and secondly, to cool the condensor 44 for condensation of the refrigerant vapour of the refrigeration system into liquid refrigerant for effecting cooling of the evaporator upon being allowed to subsequently expand. The passage of the air through the compressor chamber also serves to cool the compressor 46 and its coupling to the output shaft of the wind turbine.

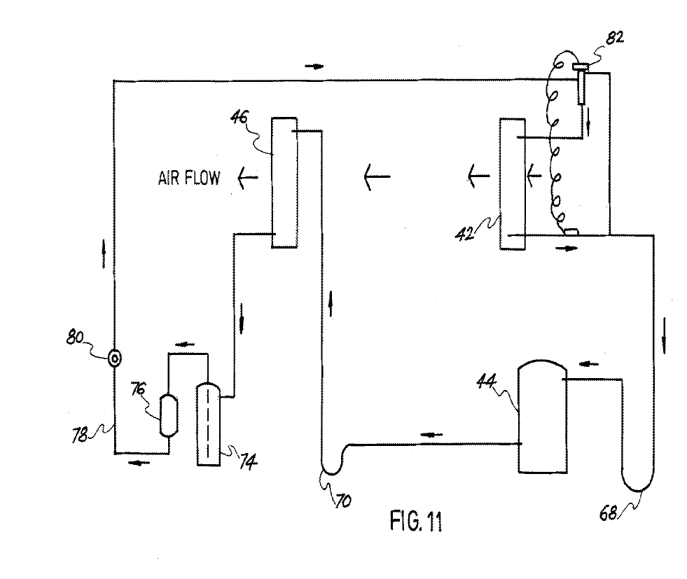

A wind turbine 20 typically requires a wind speed of at least about 6-7 m/s before it will rotate. Generally, a wind speed of at least about 2.0 m/s through the housing 36 of the wind turbine is required to create turbulent air flow therethrough for efficient condensation of water from the air and cooling of respective components of the refrigeration system. Water can, therefore, be effectively condensed from the air whenever there is sufficient wind generated by the flow of heated air from the heating enclosure 6 into the tower 4 to rotate the wind turbine. However, the flow of air through the evaporator 42 should be limited to about 3.5 m/s and preferably about 2.5 m/s to allow sufficient contact of the air with the condensation surfaces of the evaporator for condensation of the water. Accordingly, the air intake valves 54 and by-pass damper 60 are generally operated to limit air flow through the housing to this speed. Typically, the air will pass through a filter 62 prior to entering the evaporator as indicated in FIG. 11.

Rather than the compressor 46 being mechanically driven by rotation of the output shaft 28 of the wind turbine, embodiments may be provided in which the output shaft rotates an alternator 66 that generates electric power for driving the compressor 46.

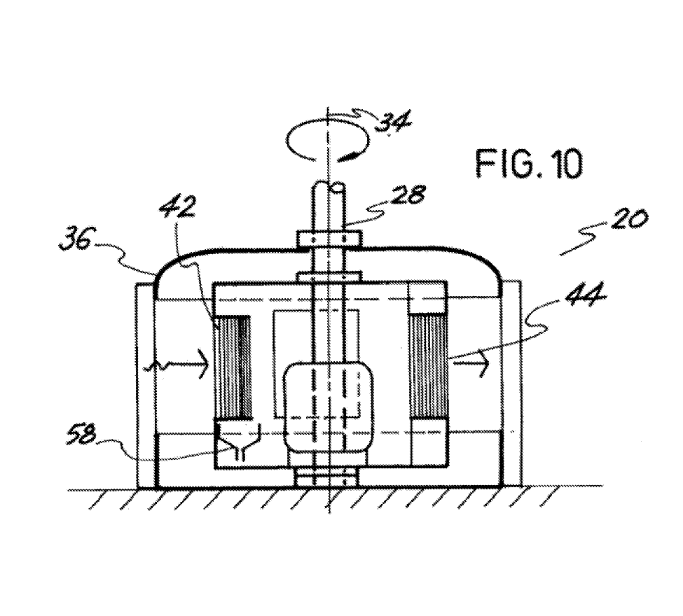

A yet further wind turbine that may be employed in an atmospheric water harvester embodied by the present invention is shown in FIG. 9. This wind turbine is provided with a rotor 64 having wind vanes rather than blades as does the wind turbine of FIG. 6. This wind turbine also differs from that shown in FIG. 6 in that the air entering the housing of the wind turbine is less affected by the rotation of the rotor 64 and primarily arises from the natural flow of air passing from the heating enclosure 6 into the tower 4. In contrast, the exhaust air from the wind turbine shown in FIG. 6 is directed into the air inlet 38 of that wind turbine and so is substantially more turbulent. Air flow through the housing of the wind turbine of FIG. 9 is shown in FIG. 10.

The refrigeration system may be either a single pressure or dual pressure system, and provides sub-cooled liquid refrigerant to the evaporator for evaporation therewithin to effect the cooling of the condensation surfaces of the evaporator for condensation of the water from the passing air. The resulting heated refrigerant vapour is drawn from the evaporator 42 and passed to the condensor 44 for condensation to liquid refrigerant as described above. To enhance thermal efficiency, heat is drawn from the compressed liquid refrigerant by the cool condensed water collected from the evaporator via a heat exchanger 72 as shown in FIG. 11.

More specifically, as shown more clearly in FIG. 11, the heated refrigerant vapour is drawn through suction loop 68 from the lower region of the evaporator 42 to the compressor 46. The suction loop 68 traps and holds any liquid refrigerant which might pass from the evaporator, thereby preventing the liquid refrigerant from entering and potentially damaging the compressor. The refrigerant vapour is compressed and thereby heated in the compressor, prior to being discharged through hot gas loop 70 to the top of the condenser 44. The hot gas loop 70 traps any liquid refrigerant draining back from the condensor to the compressor 46.

Air flowing to the condenser 44 from the evaporator cools the high pressure hot refrigerant vapour in the condenser such that the refrigerant vapour condenses. The condensed liquid refrigerant is then cooled by the condensed water passing through heat exchanger 72. The cooled liquid refrigerant subsequently drains from the bottom of the condenser 44 into reservoir 74, prior to passing from the reservoir through a filter 76 which removes any contaminants and moisture from the liquid refrigerant. From the filter 76, the refrigerant travels along conduit 78, incorporating a sight glass 80 which allows a visual check for the presence of any moisture or bubbles in the liquid refrigerant.

The conduit 78 then feeds the now dry, cooled liquid refrigerant to a thermostatic expansion valve 82. As the liquid refrigerant passes through the valve, the pressure of the liquid refrigerant decreases. The resulting low pressure cold liquid refrigerant with some flash gas is fed from the expansion valve 82 into the evaporator 42 where the liquid refrigerant evaporates back into refrigerant vapour, drawing in heat from the condensation surfaces of the evaporator. The cooled condensation surfaces in turn draw heat from the air flowing into contact with the condensation surfaces effecting cooling of the air and condensation of the moisture therefrom onto the condensation surfaces.

As described above, for efficient operation the flow rate of the air is adjusted by the air control means to optimise condensation of water per unit volume of the ambient air flowing through the evaporator 42, and to maintain sufficient air flow to the condenser for heat transfer from the condenser to the air for achieving the condensing of the refrigerant vapour in the condenser. As will be understood, the refrigeration system is operated to cool the condensation surfaces of the evaporator without freezing the condensed water.

For any given prevailing atmospheric conditions, there is a specific humidity value measured in grams of water vapour per kilogram of the air. For example, a specific humidity of between 4.5 and 6 grams of moisture per kilogram of air correlates to a dry bulb temperature of between 1° C. and 6.5° C. In use, the water collection apparatus is operated to condense water from the ambient air entering the housing 36 of a wind turbine such that the specific humidity of the air flowing from the evaporator to the condensor is reduced to a specific humidity correlating with a selected reference dry bulb temperature. The selected dry bulb temperature will typically be in the above temperature range and usually, will be in a range of from about 3.5° C. to about 5.5° C. and preferably, will be about 5° C. or below.

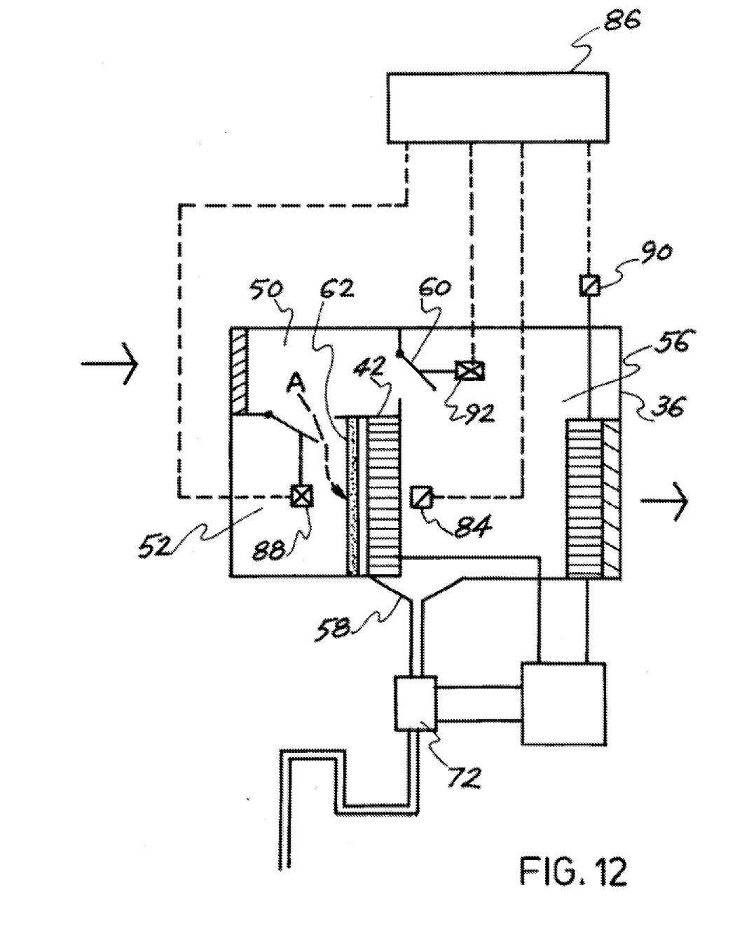

Turning now to FIG. 12, a temperature sensor 84 is provided for measuring the dry bulb temperature of the air passing from the evaporator 42 to the condensor 44. This temperature is compared by an automatic operation control system 86 with the selected reference dry bulb temperature which has been manually set in the control module. If the dry bulb temperature measured by the temperature sensor 84 increases above the set reference dry bulb temperature, the operation control system operates actuator 88 such that air intake 54 partially closes, thereby decreasing air flow through the evaporator 42. This in turn lowers the dry bulb temperature of the air leaving the evaporator.

As the flow rate of the air leaving the evaporator is decreased, the amount of cooled air from the evaporator available for cooling the condensor 44 also decreases. This results in a rise in the pressure of the refrigerant vapour in the condensor above the optimum pressure for the fixed refrigeration capacity of the refrigeration system. The pressure of the refrigerant vapour in the condensor is measured by a pressure sensor 90. In response to the increased pressure measured by the pressure sensor, the operation control system 86 operates actuator 92 to open. This increases the flow rate of air flowing to the condensor while simultaneously substantially maintaining the flow rate of the air A to the evaporator. The increased flow rate of air to the condensor removes heat from the condensor such that the pressure of the refrigerant vapour in the condensor reduces to the optimum pressure for condensation of the compressed refrigerant vapour.

The operation control system 86 continues to monitor the dry bulb temperature of the air leaving the evaporator 42 and the pressure of the refrigerant vapour in the condensor 44 is respectively measured by temperature sensor 84 and pressure sensor 90. If the dry bulb temperature sensed by the temperature sensor decreases below the set reference dry bulb temperature, the operation control system 86 operates to increase the speed of air flowing through the evaporator and decreases the flow of air by-passing the evaporator through by-pass damper 60.

The monitoring is repeated at regular intervals to ensure optimum efficiency of the apparatus and thereby, maximum condensation of water from the air. The provision of such timing circuits is well within the scope of persons skilled in the art. For different latitudes or atmospheric conditions, the reference dry bulb temperatures set in the controller 86 may be adjusted. The operation control system may comprise a central computerised control system that monitors the operation of each of the water collection apparatus, or control modules each of which monitors the operation of water collection apparatus associated with at least one wind turbine 20.

The level of water collected in the holding tank from the condensation surfaces of the evaporator is monitored by float switches or other suitable water level sensing arrangements. Suitable such systems are for instance described in International Patent Application No PCT/AU2004/001754, the contents of which are also expressly incorporated herein in their entirety. When sufficient water accumulates in the holding tank, it is pumped from the holding tank to an external storage reservoir which may be in the form of an open dam or a larger tank from where the water can be pumped to consumers.

While the water will normally be condensed from the heated air flowing to the tower from the heating enclosure 6 as shown in the accompanying figures, other embodiments may be provided wherein air is ducted to the water collection apparatus associated with the wind turbine(s) through conduits from exterior of the heating enclosure without being heated within the heating enclosure with the air that flows from the heating enclosure to the tower. Similarly, the exhaust air from the water collection apparatus may be returned to the atmosphere via return conduits or otherwise be expelled into the tower for return to the atmosphere. In such embodiments, the air may be drawn through the inlet conduits by fans arranged within the housing(s) of the wind turbine(s) or by rotors arranged within the housings that are coupled or otherwise driven by the wind turbine(s) or the draught within the heating chamber.

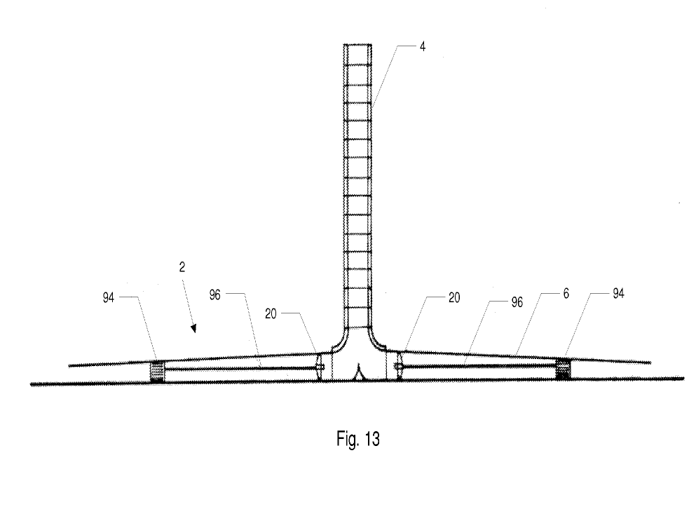

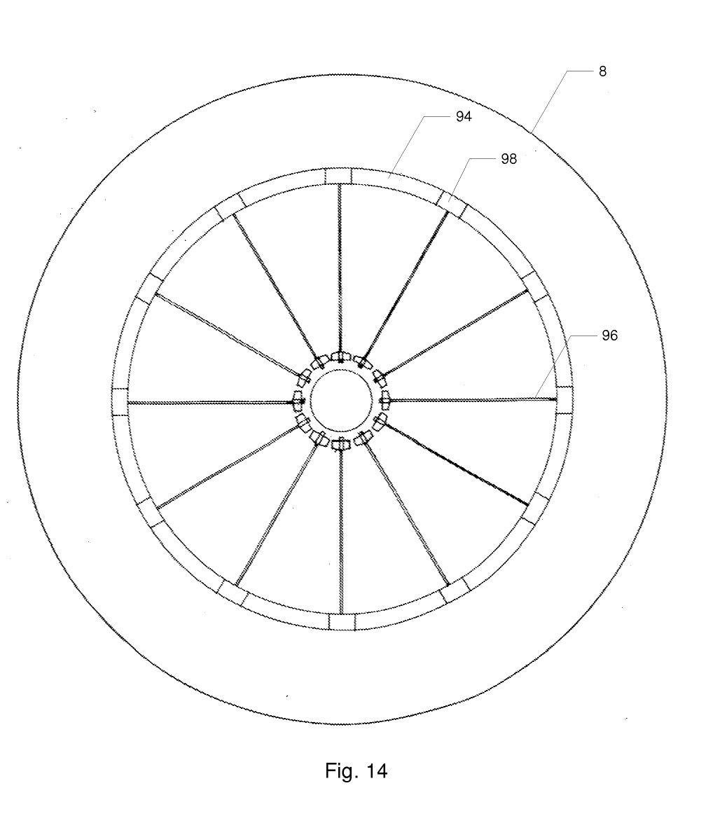

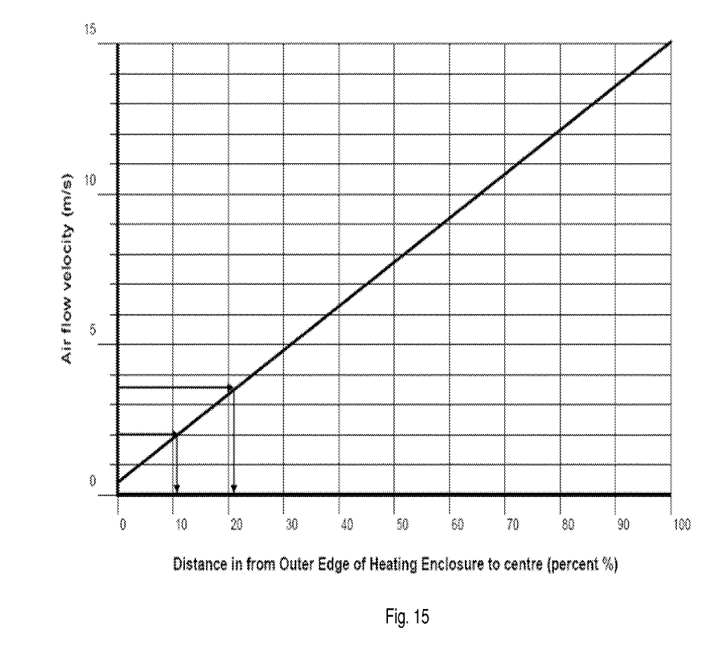

In the embodiment illustrated in FIGS. 13 and 14 the water collection apparatuses 94 are remote from the wind turbines. More particularly, the water collection apparatuses 94 are disclosed at positions within the heating enclosure 6 at which the average velocity of the air returning to the atmosphere, whilst in use, is within a range of between approximately 2.0 m/s and 3.5 m/s. In contrast, the wind turbines 20 are generally disposed at positions of maximum average air speed velocity so as to maximise their power output. The average air velocity profile that arises within the heating enclosure due to the escaping of air from the tower 4 generally increases from a minimum at or near the periphery 8, through to a maximum at or near the tower 4. An example of such an average air velocity profile is illustrated in the graph of FIG. 15. From this graph it can be seen that each of the water collection apparatuses 94 in this preferred embodiment are disposed at a radial distance from the outer periphery 8 of between approximately 11% and 21% of the total radius of the heating enclosure 6 so as to ensure that the average air velocity to which the water collection apparatuses 94 are exposed is within the optimum range of between approximately 2.0 m/s and 3.5 m/s. It will be appreciated, however, that alternative embodiments may have differing average air velocity profiles to that shown in FIG. 15. Hence, the optimum positioning of the water collection apparatuses 94 within such alternative embodiments should be determined with reference to the average air velocity profile that is applicable to the particular embodiment.

If it is desired to minimise the amount of refrigerating effort required to cool the air to at or below the dew point, it is generally preferable to minimise the temperature of the air incident upon the condensation surfaces. Hence, in some embodiments (not illustrated) the water collection apparatuses are positioned within the heating enclosure with this in mind. A typical air temperature profile generally increases from a minimum air temperature at or near the periphery of the heating enclosure, through to a maximum air temperature at or near the tower 4. It therefore follows that positioning the water collection apparatuses at or proximate to the periphery of the heating enclosure is optimum if it is desired to reduce the incident air temperature. In this way it is possible to ensure that the average temperature of the air that is incident upon the condensing surface is no more than approximately 15° C. or 110° C. or preferably 5° C. greater than, or substantially equal to, the ambient temperature of the air that enters at the periphery of the heating enclosure.

The embodiments described in the preceding two paragraphs entail a physical separation of the wind turbines 20 from the condensation surfaces of the water collection apparatuses 94. In the embodiment illustrated in FIGS. 13 and 14, the wind turbines 20 are mechanically coupled to the water collection apparatuses 94 by means of rotatably mounted elongate drive shafts 96 extending from each wind turbine 20 to a respective refrigeration system 98 associated with a respective water collection apparatus 94. In an alternative embodiment the wind turbines are electrically coupled to the compressors of the water collection apparatuses by means of an electrical generator driven by the wind turbine so as to generate electricity that is conducted via conductors extending between the turbine to drive the compressor. In yet another alternative embodiment, the refrigeration system is disposed adjacent the wind turbine such that, in use, the refrigeration system is driven by the wind turbine to produce chilled gases that are communicated along thermally insulated pipes that extend from the refrigeration system to the condensation surface.

Preferred forms of solar atmospheric water harvesters embodied by the present invention therefore provide at least one of a number of advantages including:
the utilisation of solar energy as a power source for the production of water;
the air leaving the water collection apparatuses is dehumidified as compared to the air entering the heating enclosure, thereby assisting to lessen corrosion problems within the heating chamber and tower;
the avoidance of air pollution associated with coal or other fuel fired power stations; and
the production of large quantities of replenishable potable water.

It will be appreciated by persons skilled in the art that numerous variations and/or modifications may be made to the invention as shown in the specific embodiments without departing from the spirit or scope of the invention as broadly described. Accordingly, the specific embodiments illustrated are preferred and not limiting. For example, rather than a flue comprising an upright tower as shown in the accompanying figures, an embodiment may be provided in which the flue is in the form of a heat outlet pipe which follows the upward slope of a hill or mountainside, the pipe being supported at regular intervals along its length up the hill or mountainside by mounts to which the pipe is secured by brackets. The pipe may also be formed from a material transparent to at least some solar energy or, for instance, have a transparent side facing the sun, for facilitating further heating of the air within the pipe by incident solar energy as the air flows upwardly within the pipe. As will be understood, the heating enclosure 6 may also be situated on the side of a hill or inclined ground to maximise exposure of the canopy 16 of the enclosure to incident solar energy. Alternatively, or as well, the canopy may have a number of inclined surfaces, each being disposed to maximise the surface area of the heating enclosure exposed to the incident solar energy at different times during the day, respectively. For instance, an eastern side of the canopy may be inclined to face the rising sun during morning hours while a western side of the canopy has an opposite inclination so as to face the sun in the latter part of the afternoon.

1. An atmospheric water harvester, comprising:
a heating enclosure adapted to receive air from the atmosphere and be heated by solar energy to effect heating of the air;
a flue for return of the air from the heating enclosure to the atmosphere, the flue opening to the atmosphere at a sufficient height relative to the heating enclosure to create a draught within the flue;
at least one wind turbine arranged to be driven by the air returning to the atmosphere via the flue from the heating enclosure; and
at least one water collection apparatus comprising at least one condensation surface, and a refrigeration system for cooling the condensation surface to, or below, a dew point of the air to effect the condensation of airborne moisture onto the condensation surface for collection, the refrigeration system including a compressor for compressing refrigerant vapour and a condenser for condensing the compressed refrigerant vapour into liquid refrigerant, and the wind turbine being arranged to drive the compressor.

2. An atmospheric water harvester according to claim 1 wherein the condensation surface is arranged for contact with the air heated in the heating enclosure as the air returns to the atmosphere via the flue, the airborne moisture being condensed from the heated air.

3. An atmospheric water harvester according to claim 1 wherein the condensation surface is arranged for contact with further air from the atmosphere other than the air heated within the heating enclosure, the airborne moisture being condensed from the further air.

4. An atmospheric water harvester according to claim 1 wherein the wind turbine is coupled to the compressor for driving the compressor.

5. An atmospheric water harvester according to claim 4 wherein a gear box couples an output shaft of the wind turbine to the compressor.

6. An atmospheric water harvester according to claim 1 wherein the wind turbine is coupled to an electric generator for generating electricity to power operation of the compressor.

7. An atmospheric water harvester according to claim 1 wherein the water collection apparatus further comprises water collection means for collecting water condensed onto the condensation surface from the airborne moisture and a holding reservoir disposed to receive the water from the water collection means.

8. An atmospheric water harvester according to claim 1 wherein the refrigeration system further comprises an evaporator for evaporation of the liquid refrigerant into refrigerant vapour to effect the cooling of the condensation surface and wherein the condensation surface is a surface of the evaporator.

9. An atmospheric water harvester according to claim 8 wherein the condenser is arranged for contact with air flowing from the condensation surface for cooling of the condenser to facilitate the condensing of the compressed refrigerant vapour into the liquid refrigerant.

10. An atmospheric water harvester according to claim 1 wherein the atmospheric water harvester further comprises an air flow control means for controlling a flow rate of the air flowing into contact with the condensation surface.

11. An atmospheric water harvester according claim 10 wherein the air flow control means incorporates at least one adjustable air inlet operable to allow the air to flow to the condenser, thereby by-passing contact with the condensation surface such that the flow rate of the air flowing into contact with the condenser is adjusted compared to the flow rate of the air flowing into contact with the condensation surface.

12. An atmospheric water harvester according to claim 1 wherein the heating enclosure comprises a plurality of radially directed heating chambers disposed around the tower and which open to a base region of the flue, each heating chamber being respectively provided with one or more air inlets for entry of the air from the atmosphere.

13. An atmospheric water harvester according to claim 12 wherein the, or each, wind turbine is arranged in a central region of the heating enclosure in which the flue is disposed.

14. An atmospheric water harvester according to claim 1 wherein the at least one wind turbine is arranged within a lower region of the flue.

15. An atmospheric water harvester according to claim 1 comprising a plurality of wind turbines, the wind turbines being radially orientated with respect to the central region of the heating enclosure and circumferentially spaced apart from each other.

16. An atmospheric water harvester according to claim 12 comprising a plurality of wind turbines, the wind turbines being radially orientated with respect to the central region of the heating enclosure and circumferentially spaced apart from each other and wherein each wind turbine is arranged to be driven by air flowing from a corresponding one of the heating chambers, respectively.

17. An atmospheric water harvester according to claim 1 wherein the flue is substantially vertical.

18. An atmospheric water harvester according to claim 1 wherein the flue extends upwardly from the heating enclosure at an oblique angle relative to the horizontal.

19. An atmospheric water harvester according to claim 1 wherein the at least one water collection apparatus is disclosed at a position within the heating enclosure at which the average velocity the air returning to the atmosphere, whilst in use, is within a range of between 2.0 m/s and 3.5 m/s.

20. An atmospheric water harvester according to claim 1 wherein the at least one water collection apparatus is disclosed at a position within the heating enclosure at which the average temperature of the air returning to the atmosphere, whilst in use, is substantially equal to, or no more than 5° C. greater than, an ambient temperature of air at a periphery of the heating enclosure.

21. An atmospheric water harvester according to claim 20 wherein the wind turbine is mechanically coupled to the compressor by means of a rotatably mounted drive shaft extending from the turbine to the compressor.

22. An atmospheric water harvester according to claim 20 wherein the turbine is electrically coupled to the compressor by means of an electrical generator driven by the wind turbine so as to generate electricity that is conducted via conductors extending between the turbine to the compressor.

23. An atmospheric water harvester according to claim 20 wherein the refrigeration system is disposed adjacent the wind turbine such that, in use, the refrigeration system is driven by the turbine to produce chilled gases that are communicated along at least one thermally insulated pipe from the refrigeration system to the condensation surface.
